(19) United States
(12) Patent Application Publication
(10) Pub. No.: US 2025/0380639 A1
(43) Pub. Date: Dec. 18, 2025

(54) SYSTEM AND METHOD FOR STABILITY MONITORING FOR AGRICULTURAL HARVESTERS

(71) Applicant: CNH Industrial Brasil Ltda., Bairro Vale do Sereno, Nova Lima (BR)

(72) Inventors: GIULIANO DA COSTA MAESTRO, Piracicaba (BR); JOÃO AUGUSTO MARCOLIN LUCCA, Piracicaba (BR); ANDRÉ LUÍS PAVAN, Piracicaba (BR)

(21) Appl. No.: 18/875,959

(22) PCT Filed: Jun. 24, 2023
(86) PCT No.: PCT/BR2023/050211

§ 371 Date: Dec. 17, 2024

(30) Foreign Application Priority Data
Jun. 27, 2022 (BR) 1020220128243

(51) Int. Cl. A01D 41/127; A01D 45/10

(52) U.S. Cl. CPC A01D 41/127; A01D 45/10

(57) ABSTRACT

A method for monitoring the stability of an agricultural harvester includes receiving position-related data associated with a current position of one or more actuatable components of the agricultural harvester and speed-related data associated with a current speed of the agricultural harvester. The method also includes determining an initial overturn angle for the agricultural harvester based at least in part on the position-related data, and adjusting the initial overturn angle based at least in part on the speed-related data to generate a speed-adjusted overturn angle for the agricultural harvester. Additionally, the method includes comparing a current stability angle of the agricultural harvester to at least one threshold angle determined based at least in part on the speed-adjusted overturn angle, and executing a control action when it is determined that the current stability angle of the agricultural harvester exceeds the at least one threshold angle.

### FIELD OF THE INVENTION

The present subject matter relates generally to agricultural harvesters, such as sugarcane harvesters, and, more particularly, to systems and methods for automatically monitoring the stability of an agricultural harvester during operation of the harvester.

### BACKGROUND OF THE INVENTION

Various different agricultural harvesters are used for performing harvesting operations. A sugarcane harvester typically includes an elevator assembly positioned at its rear end for conveying harvested sugarcane upwardly from a hopper downstream of the chopper assembly to a discharge point at which the sugarcane can be expelled into an associated transport vehicle. Due to the vehicle's architecture and long suspension, the harvester typically has a relative high center of gravity, which can make it susceptible to tipping or turning over when operating on inclined surfaces. Accordingly, within the manual-based specifications of the harvester, an operator is typically given a single, maximum inclination angle at which the harvester can be safely operated. However, this maximum inclination angle is based on a worst case scenario and does not account for the various different operating states, conditions, and/or parameters of the harvester. As such, the operation of the harvester is often limited in instances in which it may otherwise be safe to traverse across a given inclined surface.

Moreover, with conventional harvesters, the operator is often required to estimate or guess at the current inclination of the harvester and whether the harvester is likely close to its tipping point. As a result, operation on inclined surfaces typically requires highly skilled operators to ensure that a tip over or turnover event does not occur.

Accordingly, systems and methods for automatically monitoring the stability of an agricultural harvester would be welcomed in the technology.

### BRIEF DESCRIPTION OF THE INVENTION

Aspects and advantages of the invention will be set forth in part in the following description, or may be obvious from the description, or may be learned through practice of the invention.

In one aspect, the present subject matter is directed to a method for monitoring the stability of an agricultural harvester. The method includes receiving, with one or more computing devices, position-related data associated with a current position of one or more actuatable components of the agricultural harvester and speed-related data associated with a current speed of the agricultural harvester. The method also includes determining, with the one or computing devices, an initial overturn angle for the agricultural harvester based at least in part on the position-related data, and adjusting, with the one or more computing devices, the initial overturn angle based at least in part on the speed-related data to generate a speed-adjusted overturn angle for the agricultural harvester. Additionally, the method includes comparing, with the one or more computing devices, a current stability angle of the agricultural harvester to at least one threshold angle determined based at least in part on the speed-adjusted overturn angle, and executing, with the one or more computing devices, a control action when it is determined that the current stability angle of the agricultural harvester exceeds the at least one threshold angle.

In another aspect, the present subject matter is directed to a system for monitoring the stability of an agricultural harvester. The system includes a position sensor configured to generate position-related data associated with a current position of one or more actuatable components of the agricultural harvester, and a speed sensor configured to generate speed-related data associated with a current speed of the agricultural harvester. The system also includes a computing system communicatively coupled to the position sensor and the speed sensor. The computing is configured to: determine an initial overturn angle for the agricultural harvester based at least in part on the position-related data received from the position sensor; adjust the initial overturn angle based at least in part on the speed-related data received from the speed sensor to generate a speed-adjusted overturn angle for the agricultural harvester; compare a current stability angle of the agricultural harvester to at least one threshold angle determined based at least in part on the speed-adjusted overturn angle; and execute a control action when it is determined that the current stability angle of the agricultural harvester exceeds the at least one threshold angle.

In a further aspect, the present subject matter is directed to an agricultural harvester. The harvester includes a chassis and a topper assembly, an extractor, and an elevator assembly supported relative to the chassis. The system also comprises a plurality of actuators including at least one suspension actuator configured to adjust a current position of the chassis relative to the ground, at least one topper actuator configured to adjust a current position of the topper assembly relative to the chassis, at least one extractor actuator configured to adjust a current position of the extractor relative to the chassis, and at least one elevator actuator configured to adjust a current position of the elevator assembly relative to the chassis. Additionally, the system includes a computing system including a processor and associated memory, with the memory storing instructions that, when executed by the processor, configure the computing system to: determine an initial overturn angle for the agricultural harvester based at least in part on the position-related data received from the position sensor; adjust the initial overturn angle based at least in part on the speed-related data received from the speed sensor to generate a speed-adjusted overturn angle for the agricultural harvester; determine at one threshold angle based at least in part on the speed-adjusted overturn angle; and compare a current stability angle of the agricultural harvester to the at least one threshold angle.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 illustrates a simplified, side view of one embodiment of an agricultural harvester in accordance with aspects of the present subject matter;

FIG. 2 illustrates a schematic view of one embodiment of a system for monitoring the stability of an agricultural harvester in accordance with aspects of the present subject matter;

FIG. 3 illustrates a flow diagram of one embodiment of control logic that may be implemented by a computing system for monitoring the stability of an agricultural harvester in accordance with aspects of the present subject matter; and

FIG. 4 illustrates a flow diagram of one embodiment of a method for monitoring the stability of an agricultural harvester in accordance with aspects of the present subject matter.

### DETAILED DESCRIPTION OF THE INVENTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

In general, the present subject matter is directed to systems and methods for automatically monitoring the stability of an agricultural harvester during operation of the harvester. Specifically, in several embodiments, the disclosed systems and methods allow for the real-time calculation of an overturn angle for the harvester (e.g., an angle at which the harvester is expected to begin to tip or roll over). For example, a computing system may be configured to continuously monitor the various operating states, conditions, and/or parameters of the harvester and continuously calculate a new or instantaneous overturn angle for the harvester to account for changes in such operating states, conditions, and/or parameters. The dynamically calculated overturn angle may then be utilized by the computing system to assess the stability of the harvester and to make determinations regarding the execution of control actions. For instance, the computing system may be configured to automatically generate an operator notification and/or automatically adjust the operation of the harvester based on the monitored stability of the harvester.

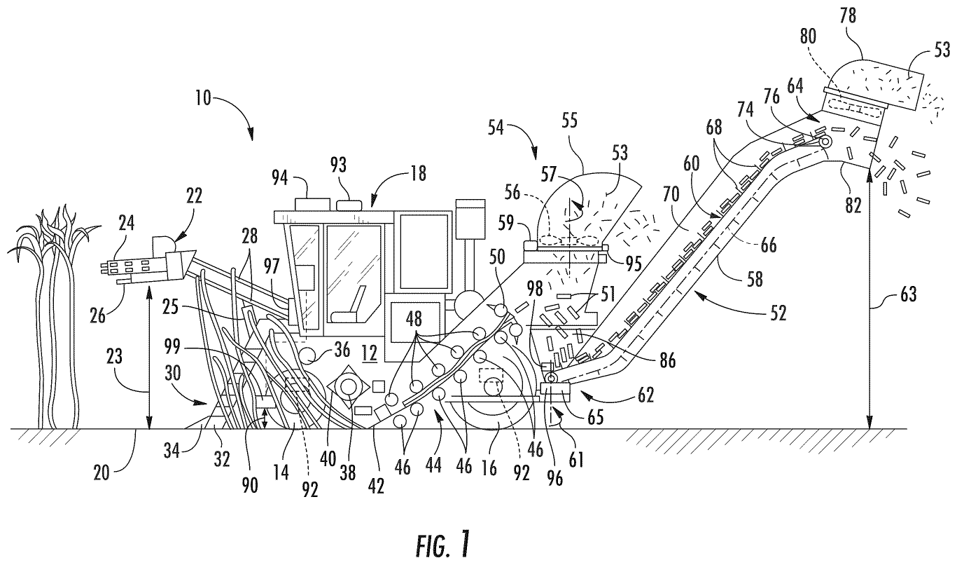

Referring now to the drawings, FIG. 1 illustrates a side view of one embodiment of a sugarcane harvester 10 in accordance with aspects of the present subject matter. As shown in FIG. 1, the harvester 10 includes a frame or chassis 12, a pair of front wheels 14, a pair of rear wheels 16, and an operator's cab 18. The harvester 10 also includes a primary source of power (e.g., an engine mounted on the chassis 12) which powers one or both pairs of the wheels 14, 16 via a transmission (not shown). Alternatively, the harvester 10 may be a track-driven harvester and, thus, may include tracks driven by the engine as opposed to the illustrated wheels 14, 16. The engine may also drive a hydraulic fluid pump (not shown) configured to generate pressurized hydraulic fluid for powering various hydraulic components of the harvester 10.

Additionally, the harvester 10 includes various components for cutting/harvesting, processing, cleaning, and discharging sugarcane as the cane is harvested from an agricultural field 20. For instance, the harvester 10 includes a topper assembly 22 positioned at its front end to intercept sugarcane as the harvester 10 is moved in the forward direction. As shown, the topper assembly 22 includes one or more gathering disks 24 and one or more cutting disks 26. The gathering disk(s) 24 may be configured to gather the sugarcane stalks so that the cutting disk(s) 26 may be used to cut off the leafy top of each plant. As is generally understood, an operating height 23 of the topper assembly 22 relative to the field 20 may be adjustable to maintain the cutting disk(s) 26 at a desired vertical position relative to the sugarcane being harvested. For instance, the harvester 10 may include one or more topper actuators 25 coupled between the chassis 12 and one or more topper arm(s) 28 that support the gathering disk(s) 24 and cutting disk(s) 26 in a cantilevered arrangement relative to the field 20. In such an embodiment, the topper actuator(s) 25 may be used to raise/lower the topper arm(s) 28 and, thus, the topper assembly 22 to adjust the cutting height 23 relative to the field 20.

Additionally, the harvester 10 includes a crop divider 30 that extends upwardly and rearwardly from the field 20. In general, the crop divider 30 may include two spiral feed rollers 32. Each feed roller 32 includes a ground shoe 34 at its lower end to assist the crop divider 30 in gathering the sugarcane stalks for harvesting. Moreover, as shown in FIG. 1, the harvester 10 includes a knock-down roller 36 positioned near the front wheels 14 and a fin roller 38 positioned behind the knock-down roller 36. As the knock-down roller 36 is rotated, the sugarcane stalks being harvested are knocked down while the crop divider 30 gathers the stalks from agricultural field 20. Further, as shown in FIG. 1, the fin roller 38 includes a plurality of intermittently mounted fins 40 that assist in forcing the sugarcane stalks downwardly. As the fin roller 38 is rotated during the harvest, the sugarcane stalks that have been knocked down by the knock-down roller 36 are separated and further knocked down by the fin roller 38 as the harvester 10 continues to be moved in the forward direction relative to the field 20.

Referring still to FIG. 1, the harvester 10 also includes a base cutter assembly 42 mounted on the chassis 12 behind the fin roller 38. As is generally understood, the base cutter assembly 42 includes blades (not shown) for severing the sugarcane stalks as the cane is being harvested. The blades, located on the periphery of the assembly 42, may be rotated by a hydraulic motor (not shown) powered by the vehicle's hydraulic system. As indicated above, the base cutter assembly 42 is generally provided in a fixed positional relationship with the chassis 12, thereby requiring the entire machine to be raised and lowered to adjust the vertical positioning of the assembly 42 when encountering variations in the ground contour.

Moreover, the harvester 10 includes a feed roller assembly 44 located downstream of the base cutter assembly 42 for moving the severed stalks of sugarcane from base cutter assembly 42 along the processing path. As shown in FIG. 1, the feed roller assembly 44 includes a plurality of bottom rollers 46 and a plurality of opposed, top pinch rollers 48. The various bottom and top rollers 46, 48 are generally used to pinch the harvested sugarcane during transport. As the sugarcane is transported through the feed roller assembly 44, debris (e.g., rocks, dirt, and/or the like) is allowed to fall through bottom rollers 46 onto the field 20.

In addition, the harvester 10 includes a chopper assembly 50 located at the downstream end of the feed roller assembly 44 (e.g., adjacent to the rearward-most bottom and top feed rollers 46, 48). In general, the chopper assembly 50 is used to cut or chop the severed sugarcane stalks into pieces or “billets” 51, which may be, for example, six (6) inches long. The billets 51 may then be propelled towards an elevator assembly 52 of the harvester 10 for delivery to an external receiver or storage device (not shown).

As is generally understood, pieces of debris 53 (e.g., dust, dirt, leaves, etc.) separated from the sugarcane billets 51 are expelled from the harvester 10 through a primary extractor 54, which is located immediately behind the chopper assembly 50 and is oriented to direct the debris 53 outwardly from the harvester 10. The primary extractor 54 may include, for example, an extractor hood 55 and an extractor fan 56 mounted within the hood 55 for generating a suction force or vacuum sufficient to pick up the debris 53 and force the debris 53 through the hood 55. The separated or cleaned billets 51, heavier than the debris 53 being expelled through the extractor 54, may then fall downward to the elevator assembly 52.

In several embodiments, the primary extractor 54 may be rotatable about a rotational axis (e.g., a substantially vertical rotation axis) to adjust an extractor swing angle (indicated by in arrow 57 FIG. 1) of the primary extractor 54 relative to the chassis 12 of the harvester 10. For instance, the primary extractor 54 may be coupled to an adjacent portion of the harvester 10 via a slewring bearing or other suitable rotational coupling. As such, the extractor 54 may be rotatable about the rotational axis to adjust the extractor swing angle 57 such that the extractor 54 expels debris 53 from the harvester 10 at a given angle or orientation relative to the direction of travel of the harvester 10, such as by orienting the extractor 54 to expel debris outwardly from the harvester 10 along the left-side, the right-side, and/or the rear side of the harvester 10. Specifically, in one embodiment, the extractor 54 may be rotatable about the rotational axis across a range of various swing angles 57 (including a 360 degree rotational range and any subranges therein). As shown schematically in FIG. 1, to facilitate such rotation of the primary extractor 54, the harvester 10 may include an extractor actuator 59 configured to rotate the extractor 54 about the rotational axis relative to the chassis 12 of the harvester 10.

As shown in FIG. 1, the elevator assembly 52 generally includes an elevator housing 58 and an elevator 60 extending within the elevator housing 58 between a lower, proximal end 62 and an upper, distal end 64. In general, the elevator 60 includes a looped chain 66 and a plurality of flights or paddles 68 attached to and evenly spaced on the chain 66. The paddles 68 are configured to hold the sugarcane billets 51 on the elevator 60 as the billets are elevated along a top span 70 of the elevator 70 defines between its proximal and distal ends 62, 64. Additionally, the elevator 60 includes lower and upper sprockets positioned at its proximal and distal ends 62, 64, respectively. As shown in FIG. 1, an elevator motor 76 is coupled to one of the sprockets (e.g., the upper sprocket) for driving the chain 66, thereby allowing the chain 66 and the paddles 68 to travel in an endless loop between the proximal and distal ends 62, 64 of the elevator 60.

In several embodiments, the elevator assembly 52 may be rotatable about a first rotational axis (e.g., a substantially vertical rotation axis) to adjust an elevator swing angle (indicated by arrow 61 in FIG. 1) of the elevator assembly 52 relative to the chassis 12 of the harvester 10. For instance, the elevator assembly 52 may be coupled to an adjacent portion of the harvester 10 via a slewring bearing or other suitable rotational coupling. As such, the elevator assembly 52 may be rotatable about the first rotational axis to adjust the elevator swing angle 61 such that the elevator assembly 52 extends outwardly from the chassis 12 at a given angle or orientation relative to the direction of travel of the harvester 10, such as by orienting the elevator assembly 52 to extend outwardly from the harvester 10 along the left-side, the right-side, and/or the rear side of the harvester 10. Specifically, in one embodiment, the elevator assembly 52 may be rotatable about the first rotational axis across a range of various swing angles 61 (including a 360 degree rotational range and any subranges therein). Additionally, in several embodiments, the elevator assembly 52 may be pivotable about a second rotational axis (e.g., a substantially horizontal rotation axis) to adjust an operating height 63 of the elevator assembly 52 relative to the ground 20. For instance, the elevator assembly 52 may be coupled to an adjacent portion of the harvester via a pivot joint or coupling to allow the elevator assembly 52 to be raised and lowered to adjust the associated operating height 63. As shown schematically in FIG. 1, to facilitate such movement of the elevator assembly 52, the harvester 10 may include one or more elevator actuators 65. For instance, in one embodiment, the harvester 10 may include a first elevator actuator 65 configured to rotate the elevator assembly 52 about the first rotational axis to adjust the swing angle 61 of the elevator assembly 52 and a second elevator actuator 65 configured to pivot the elevator assembly 52 about the second rotational axis to adjust the operating height 63 of the elevator assembly 52.

Moreover, in some embodiments, pieces of debris 53 (e.g., dust, dirt, leaves, etc.) separated from the elevated sugarcane billets 51 may be expelled from the harvester 10 through a secondary extractor 78 coupled to the rear end of the elevator housing 58. For example, the debris 53 expelled by the secondary extractor 78 may be debris remaining after the billets 51 are cleaned and debris 53 expelled by the primary extractor 54. As shown in FIG. 1, the secondary extractor 78 is located adjacent to the distal end 64 of the elevator 60 and may be oriented to direct the debris 53 outwardly from the harvester 10. Additionally, an extractor fan 80 is mounted at the base of the secondary extractor 78 for generating a suction force or vacuum sufficient to pick up the debris 53 and force the debris 53 through the secondary extractor 78. The separated, cleaned billets 51, heavier than the debris 53 expelled through the extractor 78, may then fall from the distal end 64 of the elevator 60. Typically, the billets 51 may fall downwardly through an elevator discharge opening 82 of the elevator assembly 52 into an external storage device (not shown), such as a sugarcane billet cart.

Additionally, in several embodiments, the harvester 10 may include a suspension assembly configured to adjust a suspension or operating height 90 of the harvester 10. For instance, the suspension assembly may be configured to raise and lower the chassis 12 relative to the wheels 14, 16, which, in turn, may be used to raise and lower the chassis 12 (and the various harvester components supported thereon) relative to the ground 20. For instance, the suspension height 90 may be increased or decreased to adjust the ground clearance between the ground 20 and one or more components of the harvester 10. In general, the suspension assembly may have any suitable configuration that allows it to function as described herein. For instance, in one embodiment, the suspension assembly may include one or more suspension actuators 92 (e.g., pneumatic or hydraulic actuators) configured to raise/lower the chassis 12 relative to the wheels 14, 16.

During operation, the harvester 10 is traversed across the agricultural field 20 for harvesting sugarcane. The gathering disk 24 on the topper assembly 22 functions to gather the sugarcane stalks as the harvester 10 proceeds across the field 20, while the cutter disk 26 severs the leafy tops of the sugarcane for disposal along either side of harvester 10. As the stalks enter the crop divider 30, the spiral feed rollers 32 gather the stalks into the throat to allow the knock-down roller 36 to bend the stalks downwardly in conjunction with the action of the fin roller 38. Once the stalks are angled downwardly as shown in FIG. 1, the base cutter assembly 42 severs the base of the stalks from field 20. The severed stalks are then, by movement of the harvester 10, directed to the feed roller assembly 44.

The severed sugarcane stalks are conveyed rearwardly by the bottom and top feed rollers 46, 48, which compress the stalks, make them more uniform, and shake loose debris to pass through the bottom rollers 46 to the field 20. At the downstream end of the feed roller assembly 44, the chopper assembly 50 cuts or chops the compressed sugarcane stalks into pieces or billets 51 (e.g., 6 inch cane sections). The processed crop material discharged from the chopper assembly 50 is then directed as a stream of billets 51 and debris 53 into the primary extractor 54. The airborne debris 53 (e.g., dust, dirt, leaves, etc.) separated from the sugarcane billets is then extracted through the primary extractor 54 using suction created by the extractor fan 56. The separated/cleaned billets 51 then fall downwardly through an elevator hopper 86 into the elevator assembly 52 and travel upwardly via the elevator 60 from its proximal end 62 to its distal end 64. During normal operation, once the billets 51 reach the distal end 64 of the elevator 60, the billets 51 fall through the elevator discharge opening 82 to an external storage device. If provided, the secondary extractor 78 (with the aid of the extractor fan 80) blows out trash/debris 53 from harvester 10, similar to the primary extractor 54.

It should be appreciated that the harvester 10 may also be configured to include a plurality of sensors configured to monitor various operating states, conditions, and/or parameters of the harvester 10. For instance, in several embodiments, the harvester 10 may include one or more orientation sensors 93 configured to monitor the orientation of the harvester 10 relative to one or more reference axes. Specifically, in one embodiment, the orientation sensor(s) 93 may be configured to monitor a roll angle, a pitch angle, and/or a yaw angle of the harvester 10. As is generally understood, the roll angle is defined with respect to the rotational or angular orientation of the harvester 10 about a longitudinal axis extending parallel the direction of travel of the harvester 10, while the pitch angle is defined with respect to the rotational or angular orientation of the harvester 10 about a horizontal axis extending perpendicular to the longitudinal axis (and, thus, perpendicular to the direction of travel of the harvester 10). Similarly, the yaw angle is defined with respect to the rotational or angular orientation of the harvester 10 about a substantially vertical axis. In one embodiment, the orientation sensor(s) 93 may correspond to an inertial measurement unit. In another embodiment, the orientation sensor(s) 93 may correspond to any other suitable sensor or sensing device, such as a combination of an accelerometer and a gyroscope.

Additionally, the harvester 10 may include one or more speed sensors 94 configured to monitor the travel speed of the harvester 10. In one embodiment, the speed sensor(s) 94 may correspond to a satellite-based speed sensing device, such as a global positioning system (GPS) device. In other embodiments, the speed sensor(s) 94 may correspond to any other suitable sensor or sensing device configured to provide an indication of the travel speed of the harvester 10, such as a rotational speed sensor(s) provided in association with one or more components of the transmission and/or drive axle assembly of the harvester 10.

Moreover, the harvester 10 may also include one or more swing angle sensors 95, 96 configured to monitor the swing angle of one or more respective components of the harvester 10. For instance, in one embodiment, the harvester 10 may include a first swing angle sensor(s) 95 configured to monitor the swing angle 57 of the primary extractor 54 and a second swing angle sensor(s) 96 configured to monitor the swing angle 61 of the elevator assembly 52. It should be appreciated that the swing angle sensor(s) 95, 96 may generally correspond to any suitable sensor or sensing device configured to generate data indicative of the angular orientation or swing angle of the associated harvester components. For instance, in one embodiment, each swing angle sensor(s) 95, 96 may be configured to directly monitor the swing angle of its respective component (e.g., by being coupled to a portion of the extractor 54 or the elevator assembly 52 such that the sensor directly senses movement of such component) or indirectly monitor the swing angle of its respective component (e.g., by being provided in association with the respective extractor actuator 59 or elevator actuator 65 such that the sensor directly senses the operation of the actuator, which can then be correlated to the associated swing angle).

In addition, the harvester 10 may include one or more height sensors 97, 98, 99 configured to monitor the height of one or more respective components of the harvester 10. For instance, in one embodiment, the harvester 10 may include a first height sensor(s) 97 configured to monitor the operating height of the topper assembly 23, a second height sensor(s) 98 configured to monitor the operating height of the elevator assembly 52, and a third height sensor(s) 99 configured to monitor the operating height of the chassis 12. It should be appreciated that the height sensors 97, 98, 99 may generally correspond to any suitable sensor or sensing device configured to generate data indicative of the height of the associated harvester components. For instance, in one embodiment, each height sensor(s) 97, 98, 99 may be configured to directly or indirectly monitor the height of its respective component or indirectly monitor the swing angle of its respective component (e.g., by being provided in association with the respective topper actuator 25, elevator actuator 65, or suspension actuator 92 such that the sensor directly senses the operation of the actuator, which can then be correlated to the associated component height).

It should be appreciated that the specific configuration of the harvester 10 described above and shown in FIG. 1 is provided only to place the present subject matter in an exemplary field of use. In this regard, it should be apparent to those of ordinary skill in the art that the present subject matter may be readily adaptable to any manner of machine configuration that is consistent with the disclosure provided herein.

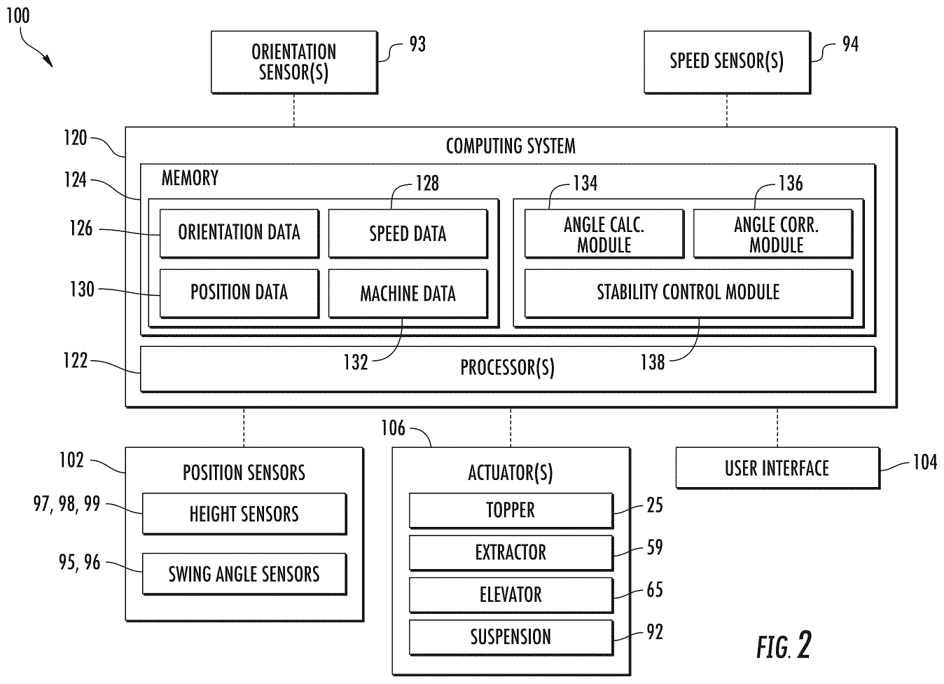

Referring now to FIG. 2, a schematic view of various components that may be included within one or more embodiments of a system 100 for monitoring the stability of an agricultural harvester is illustrated in accordance with aspects of the present subject matter. In general, the system 100 will be described herein with reference to the harvester 10 described above with reference to FIG. 1. However, in other embodiments, the disclosed system 100 may be implemented with harvesters having any other suitable harvesting configuration.

As shown in FIG. 2, the system 100 includes one or more sensors for generating data associated with one or more operating states, conditions and/or parameters of the agricultural harvester 10. Specifically, in several embodiments, the system 100 may include one or more position sensors 102 for generating position-related data associated with a current position of one or more actuatable components of the harvester 10. For instance, as described above, various position sensors may be used to generate position-related data associated with a current position (e.g., an angular orientation and/or an operating height) of the topper assembly 22, the chassis 12, the extractor 54, and/or the elevator assembly 52, such as various height sensors 97, 98, 99 to monitor the current operating height of the topper assembly 22, the elevator assembly 52, and/or the chassis 12 and various swing angle sensors 95, 96 to monitor the current swing angle of the extractor 54 and/or the elevator assembly 52. Additionally, in several embodiments, the system 100 may include one or more orientation sensors 93 configured to generated orientation-related data associated with an orientation of the harvester 10 relative to one or more reference axes (e.g., pitch, roll, and yaw axes) and one or more speed sensors 94 configured to generate speed-related data associated with the travel speed of the harvester 10.

Additionally, as shown in FIG. 2, the system 100 may also include a computing system 120 communicatively coupled to the various sensors 93, 94, 102 to allow sensor data generated by the sensors 93, 94, 102 (e.g., position-related data, speed-related data, and/or orientation-related data) to be transmitted to the computing system 120 for subsequent processing and/or analysis. In general, the computing system 120 may be configured to utilize the sensor data to monitor the stability of the harvester 10 in view of its current operating states, conditions, and/or parameters. For instance, as will be described below, the computing system 120 may be configured to analyze the position-related data to calculate an initial overturn angle for the harvester 10 (e.g., an angle determined based on the kinematics and center of gravity of the harvester at which the harvester is expected to begin to tip or roll over) based at least in part on the current position of one or more actuatable components of the harvester (e.g., the topper assembly 22, the chassis 12, the extractor 54, and/or the elevator assembly 52). Additionally, using the speed-related data, the computing system 120 may be configured to adjust or correct the initial overturn angle to generate a dynamic, speed-adjusted overturn angle for the harvester 10 that accounts for the current speed of the harvester 10. This speed-adjusted overturn angle may then be used by the computing system 120 to identify one or more threshold angles relative to which a current stability angle of the harvester 10 (e.g., as determined via the orientation-related data received from the orientation sensor(s) 93) may be monitored. When it is determined that the current stability angle of the harvester 10 exceeds one or more of the thresholds, the computing system 120 may be configured to execute one or more control actions design to inform the operator of the current stability-related condition of the harvester 10 and/or to reduce the likelihood of a turnover or tipping event during which the harvester will roll or tip over due to instability based on the inclination of the harvester 10 relative to its center of gravity.

In general, the computing system 120 may correspond to any suitable processor-based device(s), such as a computing device or any combination of computing devices. Thus, in several embodiments, the computing system 120 may include one or more processor(s) 122 and associated memory device(s) 124 configured to perform a variety of computer-implemented functions. As used herein, the term “processor” refers not only to integrated circuits referred to in the art as being included in a computer, but also refers to a controller, a microcontroller, a microcomputer, a programmable logic controller (PLC), an application specific integrated circuit, and other programmable circuits. Additionally, the memory device(s) 124 of the computing system 120 may generally comprise memory element(s) including, but not limited to, computer readable medium (e.g., random access memory (RAM)), computer readable non-volatile medium (e.g., a flash memory), a compact disc-read only memory (CD-ROM), a magneto-optical disk (MOD), a digital versatile disc (DVD) and/or other suitable memory elements. Such memory device(s) 124 may generally be configured to store suitable computer-readable instructions that, when implemented by the processor(s) 122, configure the computing system 120 to perform various computer-implemented functions, such as one or more aspects of the methods described herein.

In one embodiment, the memory 124 of the computing system 120 may include one or more databases for storing information associated with the operation of the harvester 10, including data associated with one or more operating states, conditions and/or parameters of the harvester 10. For instance, as shown in FIG. 2, the memory 124 may include an orientation database 126 storing orientation-related data associated with a current orientation of the harvester, such as data received from the orientation sensor(s) 93 associated with a current pitch angle, roll angle, and/or yaw angle of the harvester 10. Additionally, the memory 124 may include a speed database 128 storing speed-related data associated with a current travel speed of the harvester, such as speed data received from the speed sensor(s) 94. The memory 124 may also include a position database 130 storing position-related data associated with associated with a current position of one or more actuatable components of the harvester 10, such as data received from the position sensor(s) 102 associated with the current operating height of the topper assembly 22, the chassis 12, and/or elevator assembly 52 and/or the current swing angle of the extractor 54 and/or the elevator assembly 52. Moreover, the memory 124 may also include a machine parameter database 132 storing data associated with various other machine parameters and/or conditions, such as one or more fixed parameters and/or conditions that may be used to calculate an associated overturn angle for the harvester 10.

Referring still to FIG. 2, in several embodiments, the memory 124 of the computing system 120 may store instructions that, when executed by the processor(s) 122, configure the computing system 120 to execute an angle calculation module 134 for calculating an initial overturn angle for the harvester 10. In general, the initial overturn angle corresponds to an angle (as determined based on the kinematics and center of gravity of the harvester) at which the harvester is expected to begin to tip or roll over. In several embodiments, the initial overturn angle may be calculated in accordance with a methodology that is based on one or more standardized methodologies defined for determining the “static overturn angle” of an agricultural vehicle, such as the method defined by ISO 16231, ISO 789, IS10743, and/or UN ECE Regulation 66. Alternatively, the initial overturn angle may be calculated in accordance with any other suitable methodology. It should be appreciated that the calculated overturn angle may be an orientation-specific angle or a composite angle. For instance, in one embodiment, the computing system 120 may be configured to calculate both a roll-related overturn angle associated with the angle at which the harvester is expected to begin to tip or roll over about the roll axis and a pitch-related overturn angle associated with the angle at which the harvester is expected to begin to tip or roller over about the pitch axis.

Given the knowledge of one of ordinary skill in the art, a comprehensive description of the calculation of an initial or static overturn angle is not necessary, particularly given the availability of standardized calculation methodologies that can assist with formulating the calculation methodology. However, in general, it should be readily appreciated that the overturn angle will vary or differ with changes in the location of the center of gravity of the harvester 10. In this regard, the computing system is configured to continuously recalculate the overturn angle to account for variations in one or more operating states, conditions, and/or parameters of the harvester 10 that could result in a change in the location of the harvester's center of gravity. For instance, changes in one or more of the following will typically directly impact the location of the center of gravity of the harvester 10: (1) the operating height of the topper assembly 22; (2) the suspension height of the chassis 12; (3) the swing angle of the extractor 54; and/or (4) the operating height and/or the swing angle of the elevator assembly 52. As such, by continuously monitoring the current position(s) of these actuatable components, the computing system 120 may be configured to update or continuously recalculate the overturn angle for the harvester in real-time to provide an instantaneous “initial overturn angle” for the harvester in view of its current operating states, conditions, and/or parameters.

The memory 124 of the computing system 120 may also store instructions that, when executed by the processor(s) 122, configure the computing system 120 to execute an angle correction module 136 for calculating a speed-adjusted overturn angle for the harvester that takes into account the harvester's current travel speed. Specifically, in several embodiments, the computing system 120 may be configured to apply a speed-dependent correction factor to each instantaneous “initial overturn angle” calculated by the computing system 120 to generate a speed-adjusted overturn angle for the harvester 10. In instances in which both a roll-related and a pitch-related overturn angle was initially calculated by the computing system 120, a speed-dependent correction factor may be applied to each overturn angle to determine both a speed-adjusted, roll-related overturn angle and a speed-adjusted, pitch-related overturn angle.

The speed-dependent correction factor may generally be configured to reduce the “initial overturn angle” based on the current speed of the vehicle to provide an additional safety margin or buffer to the calculated overturn angle. For example, the speed-adjusted overturn angle may generally be calculated according to the following equation: [symbol]
wherein, [symbol] correspond to the speed-adjusted overturn angle, OAᵢₙᵢₜᵢₐₗ corresponds to the initially calculated overturn angle, and CF corresponds to the speed-dependent correction factor.

In one embodiment, the correction factor may generally increase with increases in the travel speed such that a larger safety margin or buffer is provided for faster travel speeds and a smaller safety margin is provided for slower travel speeds, thereby providing the operator with some flexibility in operating along different sloped or inclined ground surfaces based on the travel speed of the harvester. For instance, in one embodiment, the correction factor may be calculated as a percentage of the “initial overturn angle”, with the specific percentage varying across the speed range of the harvester. As an example, the set percentage may vary from a minimum percentage (e.g., 0%) to a maximum percentage (e.g., 50%), with the minimum percentage being applied at the minimum speed of the harvester (e.g., when the harvester is stationary), the maximum percentage being applied at the maximum speed of the harvester, and the range of percentages in-between the maximum and minimum percentages being applied across the harvester's speed range such that a different correction factor is used at each potential travel speed of the harvester. For instance, the set percentage may increase linearly or non-linearly with increases in the travel speed. Alternatively, predetermined or calculated correction factor values may be assigned to different sub-ranges of the harvester's overall speed range such that one correction factor is applied across a given sub-range of travel speeds while another correction factor is applied across a different sub-range of travel speeds. Regardless of the calculation methodology and/or the specific correction values utilized, by applying a correction factor that progressively reduces the “initial overturn angle” as a function of increases in the current travel speed of the harvester, the resulting “corrected” or speed-adjusted overturn angle may provide for enhanced operator safety in high speed situations and an increased operating range in lower speed situations while continuously maintaining a safe and stabile machine condition across all operating speeds of the harvester.

It should be appreciated that, in one embodiment, the computing system 120 may be provided with suitable mathematical formulas or expressions for calculating the “initial overturn angle” and/or the associated speed-dependent correction factor. In addition (or as an alternative thereto), the computing system 120 may include suitable look-up tables stored within its memory for determining the “initial overturn angle” and/or the associated speed-dependent correction factor.

Referring still to FIG. 2, the memory 124 of the computing system 120 may also store instructions that, when executed by the processor(s) 122, configure the computing system 120 to execute a stability control module 138 for assessing the vehicle's current stability condition and for executing control actions, if necessary, to minimize the likelihood of the occurrence of a tip over or overturn event. Specifically, in several embodiments, the computing system 120 may be configured to calculate one or more threshold angles based on the speed-adjusted overturn angle. In one embodiment, the computing system 120 may be configured to define an acceptable stability angle range for the harvester based on the speed-adjusted overturn angle, such as a range extending from plus-or-minus (+/−) the speed-adjusted overturn angle. For example, for a speed-adjusted, roll-related overturn angle of 12 degrees, the computing system may define an acceptable stability range for roll angles of +/−12 degrees. The computing system may then define one or more threshold values or ranges within the acceptable stability range for triggering certain control actions.

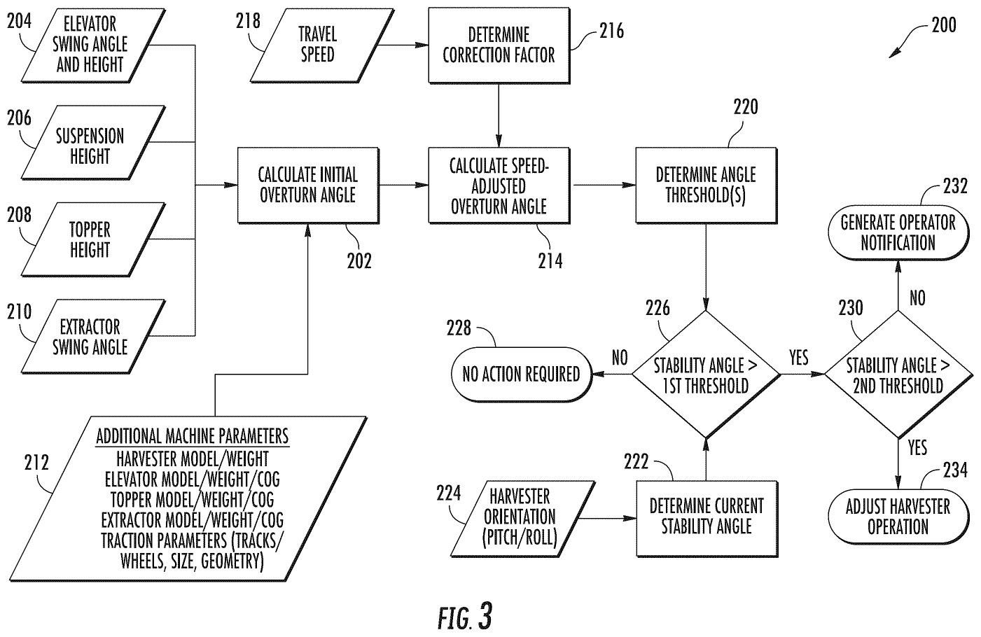

For instance, as will be described below with reference to FIG. 3, the computing system 120 may be configured to define tiered threshold ranges/values, with each threshold range/value being associated with a different control action (e.g., a different type of control action). As an example, the computing system 120 may define a first threshold range based on a first percentage of the acceptable stability range such that a pair of minimum/maximum or positive/negative first threshold values are defined across the acceptable stability range (e.g., +/−70% of the speed-adjusted overturn angle). In addition, the computing system 120 may also define a second threshold range based on a higher, second percentage of the acceptable stability range such that a pair of minimum/maximum or positive/negative second threshold values are defined across the acceptable stability range (e.g., +/−95% of the speed-adjusted overturn angle). In such an embodiment, the computing system 120 may be configured to monitor a current stability angle of the harvester 10 (e.g., the current roll angle or the current pitch angle) and execute a first control action when one of the first threshold values is exceeded by such stability angle and execute a second control action if the stability angle subsequently exceeds the higher second threshold value. With such a tiered approach, the severity or magnitude of the control action may be increased as the harvester's current stability angle increases towards the associated speed-adjusted overturn angle.

It should be appreciated the computing system 120 may be configured to execute any suitable control action in response to the determination a given stability condition of the harvester 10. In several embodiments, the computing system 120 may be configured to generate one or more notifications for providing the operator with feedback or information related to the current stability condition of the harvester 10, including a warning or other information associated with the likelihood of the occurrence of a tip over or turnover event. For instance, as shown in FIG. 2, the computing system 120 may be communicatively coupled to a user interface, such as a user interface 104 housed within the cab 18 of the harvester 10 or at any other suitable location. The user interface 104 may be configured to provide feedback to the operator of the harvester 10. Thus, the user interface 104 may include one or more feedback devices (not shown), such as display screens, speakers, warning lights, and/or the like, which are configured to communicate such feedback. In addition, some embodiments of the user interface 104 may include one or more input devices (not shown), such as touchscreens, keypads, touchpads, knobs, buttons, sliders, switches, mice, microphones, and/or the like, which are configured to receive user inputs from the operator.

In addition to operator notifications (or as an alternative thereto), the computing system 120 may be configured to automatically control or adjust the operation of the harvester 10. For instance, to reduce the likelihood of the occurrence of a tip over or turnover event, the computing system 120 may be configured to automatically reduce the travel speed of the harvester 10. In addition to speed reductions (or as an alternative thereto), the computing system 120 may be configured to control the motion of one or more of the actuatable components of the harvester 10 to shift the harvester's center of gravity in a direction opposite the direction along which the harvester is more likely to tip or turn over. Specifically, as shown in FIG. 2, the computing system 120 may be communicatively coupled to the various actuators 106 of the harvester, such as the topper actuator(s) 25, the extractor actuator(s) 59, the elevator actuator(s) 65, and/or the suspension actuator(s) 92, in a manner that allows the computing system 120 to automatically control the operation of such actuators (and, thus, automatically control the movement/actuation of the related components). For example, in an instance in which the elevator assembly 52 is extending outwardly from the harvester 10 along its left-side, the computing system 120 may be configured to actuate the elevator assembly 52 such that it is rotated or pivoted to the right-side of the harvester 10 in response to a determination of an increased likelihood of the harvester 10 rolling or turning over along its left-side, thereby allowing the elevator assembly 52 to function as a counterweight to shift the center of gravity of the harvester 10 towards the harvester's right side.

Referring now to FIG. 3, a flow diagram of one embodiment of control logic 200 that may be implemented by a computing system (e.g., computing system 120 (FIG. 2)) for monitoring the stability of an agricultural harvester is illustrated in accordance with aspects of the present subject matter. In general, the control logic 200 will be described herein with reference to the agricultural harvester 10 shown in FIG. 1, as well as the system 100 and related system components shown in FIG. 2. However, it should be appreciated that the control logic 200 may generally be executed in combination with any suitable harvester having any suitable harvesting configuration and any suitable system and having any suitable system configuration.

As shown in FIG. 3, the computing system 120 may, at (202), be configured to calculate an initial overturn angle for the harvester 10 at which the harvester is expected to begin to tip or roll over. As indicated above, the initial overturn angle may, in several embodiments, be calculated in accordance with a methodology based on one or more standardized methodologies (e.g., ISO 16231) for determining a “static overturn angle” for the harvester 10.

It should be appreciated that the calculation of such overturn angle may rely on various inputs or other data, including inputs/data that allow for the calculation of the center of gravity of the harvester 10. For instance, as shown in FIG. 3, the computing system 120 may be configured to receive position-related data associated with the current position of one or more actuatable components of the harvester 10 to allow for the calculation of the harvester's center of gravity, such as the swing angle and operating height of the elevator assembly (204), the suspension or operating height of the chassis (206), the operating height of the topper assembly height (208), and the swing angle of the extractor (210). In addition, as shown in FIG. 3, the computing system 120 may also be configured to take into account various other additional machine parameters (212) when calculating the initial overturn angle, such as: (1) the harvester model/weight; (2) the model, weight, and center of gravity of the elevator assembly, topper assembly, and extractor; (3) various traction-related parameters (e.g., tracks vs. wheels, track/tire dimension, traction-related geometries, such as the wheelbase, and/or the like); and/or (4) any other suitable inputs/data associated with the machine geometries or other parameters.

Moreover, as shown in FIG. 3, the computing system 120 may, at (214), be configured to calculate a speed-adjusted overturn angle for the harvester 10. As indicated above, the computing system 120 may be configured to apply a speed-dependent correction factor to each instantaneous “initial overturn angle” calculated by the computing system 120 to generate a speed-adjusted overturn angle for the harvester 10. The speed-dependent correction factor may, in turn, be calculated (e.g., at (216)) based on the speed-related data received from the speed sensor(s) 94 that is associated with the travel speed (218) of the harvester. As described above, in one embodiment, the correction factor may generally increase with increases in the travel speed such that the correction factor, as applied, results in a smaller speed-adjusted overturn angle at higher speeds than at lower speeds.

Additionally, as shown in FIG. 3, the computing system may, at (220), be configured to determine one or more stability angle thresholds based at least in part on the speed-adjusted overturn angle. As indicated above, the threshold value(s) may, in several embodiments, correspond to a given percentage of the speed-adjusted overturn angle.

In the embodiment shown in FIG. 3, the control logic 200 is applied such that the computing system 120 determines both a first threshold angle and a second threshold angle, with the first and second threshold angles corresponding to different percentages of the speed-adjusted overturn angle. Specifically, in the illustrated embodiment, the first threshold angle corresponds to a smaller percentage of the speed-adjusted overturn angle than the second threshold angle (e.g., 70% vs. 95%) such that, as the monitored stability angle of the harvester 10 (e.g., the roll angle or the pitch angle) increases from zero, such angle would first exceed the first threshold value (e.g., 70% of the speed-adjusted overturn angle) and would then exceed the second threshold value (e.g., 95% of the speed-adjusted overturn angle) with further increases thereof.

Moreover, in addition to determining the stability angle threshold(s), the computing system 120 is also configured to determine or monitor the current stability angle of the harvester 10. For instance, as shown in FIG. 3, the computing system 120 may, at (222), determine a current stability angle based on the orientation-related data (224) received from the orientation sensor(s) 93, such as by determining the current roll angle and/or the current pitch angle of the harvester 10. The current stability angle may then be compared to the associated stability angle thresholds to determine if a given control action is necessary and, if so, the nature of the required control action. Specifically, as shown in FIG. 3, at (226), the current stability angle is initially compared to the lower or first stability angle threshold to determine if the current stability angle exceeds such threshold. If the current stability angle does not exceed the first threshold, the computing system 120 may, at (228), determine that no immediate control action is required.

However, if the current stability angle does exceed the first threshold, the computing system 120 may, at 230, be configured to compare the current stability angle to the higher or second stability angle threshold. If the current stability angle does not exceed the second threshold (and, thus, corresponds to a value between the first and second thresholds), the computing system 120 may, at (232), be configured to execute a control action of a first type (e.g., a lower severity or magnitude control action), such as by generating an operator notification. For instance, the operator notification may correspond to a visual display or audible warning indicating that the current stability angle of the harvester 10 is approaching the limit defined by the speed-adjusted overturn angle. However, if the current stability angle does, in fact, exceed the second threshold, the computing system 120 may, at (234), be configured to execute a control action of a second type (e.g., a higher severity or magnitude control action), such as by automatically adjusting the operation of the harvester 10. For instance, the computing system 120 may be configured to take immediate action designed to reduce the likelihood of a tip over or turnover event, such as by automatically reducing the travel speed of the harvester or by automatically actuating one or more actuatable components of the harvester 10 so that the component(s) is sued as a counterweight to shift the center of gravity of the harvester 10 in the opposite direction of the likely tipping direction.

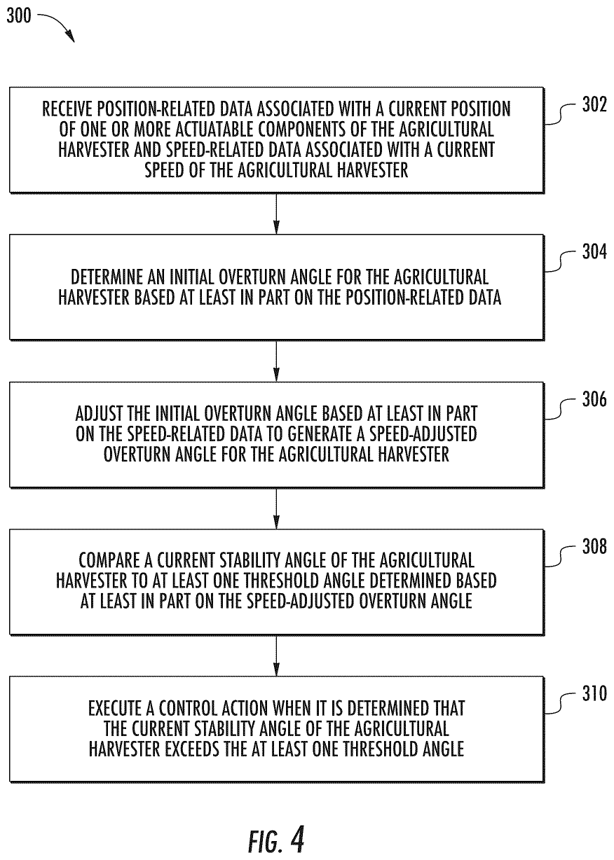

Referring now to FIG. 4, a flow diagram of one embodiment of a method 300 for monitoring the stability of an agricultural harvester is illustrated in accordance with aspects of the present subject matter. For purposes of discussion, the method 300 will generally be described herein with reference to the harvester 10 and the system 100 described above with reference to FIGS. 1 and 2. However, it should be appreciated that the disclosed method 300 may generally be executed in association with any harvester having any other suitable harvester configuration and/or any system having any other suitable system configuration. Additionally, although FIG. 4 depicts steps performed in a particular order for purposes of illustration and discussion, the methods discussed herein are not limited to any particular order or arrangement. One skilled in the art, using the disclosures provided herein, will appreciate that various steps of the methods disclosed herein can be omitted, rearranged, combined, and/or adapted in various ways without deviating from the scope of the present disclosure.

As shown in FIG. 4, at (302) the method 300 may include receiving position-related data associated with a current position of one or more actuatable components of the agricultural harvester and speed-related data associated with a current speed of the agricultural harvester. For instance, as indicated above, the computing system 120 may be configured to receive position-related data from the position sensor(s) 102 associated with the current position of various components, such as the topper assembly 22, the chassis 12, the elevator assembly 52 and the extractor 54. The computing system 120 is also configured to receive speed-related data from the speed sensor(s) 94 associated with the current travel speed of the harvester 10.

Additionally, at (304), the method 300 may include determining an initial overturn angle for the agricultural harvester based at least in part on the position-related data. Specifically, as indicated above, the computing system 120 may be configured to determine an initial overturn angle for the harvester 10 based on position-related data received from the position sensor(s) 102, such as by determining a center of gravity of the harvester 10 based on the various positions of the actuatable components of the harvester 10. The dynamically determined center of gravity may then be used as an input to calculate the initial overturn angle.

Moreover, at (306), the method 300 may include adjusting the initial overturn angle based at least in part on the speed-related data to generate a speed-adjusted overturn angle for the agricultural harvester. Specifically, as indicated above, the computing system 120 may be configured to apply a speed-dependent correction factor to the initially calculated overturn angle to generate a speed-adjusted overturn angle that provides an additional safety margin or buffer in view of the current travel speed of the harvester 10.

Referring still to FIG. 4, at (308), the method 300 may include comparing a current stability angle of the agricultural harvester to at least one threshold angle determined based at least in part on the speed-adjusted overturn angle. Specifically, as indicated above, the computing system 120 may be configured to determine one or more threshold values based on the speed-adjusted overturn angle and subsequently compare a current stability angle of the harvester 10 (e.g., the roll angle or pitch angle) to the determined threshold values. In one embodiment, as described above, the computing system 120 may be configured to utilize tiered thresholds.

Additionally, at (310), the method 300 may include executing a control action when it is determined that the current stability angle of the agricultural harvester exceeds the at least one threshold angle. For instance, as indicated above, the computing system 120 may be configured to execute one or more control actions based on the comparison of the current stability angle of the harvester 10 to the associated threshold value(s). When using the tiered thresholds, the computing system 120 may, for example, be configured to execute a control action of a first type when a lower threshold value is exceeded and execute a control action of a second type when a higher threshold value is exceeded.

It is to be understood that one or more of the steps of the method 300 are performed by a computing system 120 upon loading and executing software code or instructions which are tangibly stored on a tangible computer readable medium, such as on a magnetic medium, e.g., a computer hard drive, an optical medium, e.g., an optical disc, solid-state memory, e.g., flash memory, or other storage media known in the art. Thus, any of the functionality performed by the computing system 120 described herein, such as the method 300, is implemented in software code or instructions which are tangibly stored on a tangible computer readable medium. The computing system 120 loads the software code or instructions via a direct interface with the computer readable medium or via a wired and/or wireless network. Upon loading and executing such software code or instructions by the computing system 120, the computing system may perform any of the functionality of the computing device(s) described herein, including any steps of the method 300 described herein.

The term “software code” or “code” used herein refers to any instructions or set of instructions that influence the operation of a computer or controller. They may exist in a computer-executable form, such as machine code, which is the set of instructions and data directly executed by a computer's central processing unit or by a controller, a human-understandable form, such as source code, which may be compiled in order to be executed by a computer's central processing unit or by a controller, or an intermediate form, such as object code, which is produced by a compiler. As used herein, the term “software code” or “code” also includes any human-understandable computer instructions or set of instructions, e.g., a script, that may be executed on the fly with the aid of an interpreter executed by a computer's central processing unit or by a controller.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims or if they include equivalent structural elements with insubstantial differences from the literal language of the claims.

What is claimed is:

1. A method for monitoring the stability of an agricultural harvester, the method comprising:
receiving, with one or more computing devices, position-related data associated with a current position of one or more actuatable components of the agricultural harvester and speed-related data associated with a current speed of the agricultural harvester;
determining, with the one or computing devices, an initial overturn angle for the agricultural harvester based at least in part on the position-related data;
adjusting, with the one or more computing devices, the initial overturn angle based at least in part on the speed-related data to generate a speed-adjusted overturn angle for the agricultural harvester;
comparing, with the one or more computing devices, a current stability angle of the agricultural harvester to at least one threshold angle determined based at least in part on the speed-adjusted overturn angle; and
executing, with the one or more computing devices, a control action when it is determined that the current stability angle of the agricultural harvester exceeds the at least one threshold angle.

2. The method of claim 1, further comprising determining a correction factor based at least in part on the speed-related data, the correction factor varying as a function of the current speed of the agricultural harvester.

3. The method of claim 2, wherein adjusting the initial overturn angle comprises applying the correction factor to the initial overturn angle to generate the speed-adjusted overturn angle.

4. The method of claim 1, wherein the position-related data is associated with a current position of an elevator assembly of the agricultural harvester and a current position of at least one of a topper assembly of the agricultural harvester, an extractor of the agricultural harvester, or a chassis of the agricultural harvester.

5. The method of claim 4, wherein the current position of the elevator assembly comprises at least one of a swing angle of the elevator assembly or an operating height of the elevator assembly, the current position of the topper assembly comprises an operating height of the topper assembly, the current position of the extractor comprises a swing angle of the extractor, and the current position of the chassis comprises a suspension height of the agricultural harvester.

6. The method of claim 4, further comprising determining a center of gravity of the agricultural harvester based at least in part on the current position of the elevator assembly and the current position of the at least one of the topper assembly, the extractor, or the chassis;
wherein determining the initial overturn angle comprises determining the initial overturn angle based at least in part on the determined center of gravity of the agricultural harvester.

7. The method of claim 1, wherein determining the at least one threshold angle comprises determining a first threshold angle and a second threshold angle based at least in part on the speed-adjusted overturn angle, the first threshold angle differing from the second threshold angle; and
wherein executing the control action comprises executing a first control action when it is determined that the current stability angle exceeds the first threshold angle and executing a second control action when it is determined that the current stability angle exceeds the second threshold angle, the first control action differing from the second control action.

8. The method of claim 1, wherein executing the control action comprises generating a notification for an operator of the agricultural harvester.

9. The method of claim 1, wherein executing the control action comprises automatically adjusting an operation of the agricultural harvester.

10. The method of claim 9, wherein automatically adjusting the operation of the agricultural harvester comprises automatically adjusting the current position of at least one of the one or more actuatable components to adjust a center of gravity of the agricultural harvester or automatically reducing the current speed of the agricultural harvester.

11. The method of claim 1, wherein the current stability angle is associated with at least one of a pitch angle or a roll angle of the agricultural harvester.

12. A system for monitoring the stability of an agricultural harvester, the system comprising:
a position sensor configured to generate position-related data associated with a current position of one or more actuatable components of the agricultural harvester;
a speed sensor configured to generate speed-related data associated with a current speed of the agricultural harvester; and
a computing system communicatively coupled to the position sensor and the speed sensor, the computing system being configured to:
determine an initial overturn angle for the agricultural harvester based at least in part on the position-related data received from the position sensor;
adjust the initial overturn angle based at least in part on the speed-related data received from the speed sensor to generate a speed-adjusted overturn angle for the agricultural harvester;
compare a current stability angle of the agricultural harvester to at least one threshold angle determined based at least in part on the speed-adjusted overturn angle; and
execute a control action when it is determined that the current stability angle of the agricultural harvester exceeds the at least one threshold angle.

13. The system of claim 12, wherein the computing system is configured to determine a correction factor based at least in part on the speed-related data, the correction factor varying as a function of the current speed of the agricultural harvester.

14. The system of claim 13, wherein the computing system is configured to apply the correction factor to the initial overturn angle to generate the speed-adjusted overturn angle.

15. The system of claim 12, wherein the position-related data is associated with a current position of an elevator assembly of the agricultural harvester and a current position of at least one of a topper assembly of the agricultural harvester, an extractor of the agricultural harvester, or a chassis of the agricultural harvester.

16. The system of claim 15, wherein the computing system is further configured to determine a center of gravity of the agricultural harvester based at least in part on the current position of the elevator assembly and the current position of the at least one of the topper assembly, the extractor, or the chassis;
wherein the computing system is configured to determine the initial overturn angle based at least in part on the determined center of gravity of the agricultural harvester.

17. The system of claim 12, wherein the at least one threshold angle comprises a first threshold angle and a second threshold angle, the first threshold angle differing from the second threshold angle; and
wherein the computing system is configured to execute a first control action when it is determined that the current stability angle exceeds the first threshold angle and execute a second control action when it is determined that the current stability angle exceeds the second threshold angle, the first control action differing from the second control action.

18. The system of claim 12, wherein the control action comprises at least one generating a notification for an operator of the agricultural harvester or automatically adjusting an operation of the agricultural harvester.

19. The system of claim 12, wherein the current stability angle is associated with at least one of a pitch angle or a roll angle of the agricultural harvester.

20. An agricultural harvester, comprising:
a chassis;
a topper assembly, an extractor, and an elevator assembly supported relative to the chassis;
a plurality of actuators including at least one suspension actuator configured to adjust a current position of the chassis relative to the ground, at least one topper actuator configured to adjust a current position of the topper assembly relative to the chassis, at least one extractor actuator configured to adjust a current position of the extractor relative to the chassis, and at least one elevator actuator configured to adjust a current position of the elevator assembly relative to the chassis; and
a computing system including a processor and associated memory, the memory storing instructions that, when executed by the processor, configure the computing system to:
determine an initial overturn angle for the agricultural harvester based at least in part on the position-related data received from the position sensor;
adjust the initial overturn angle based at least in part on the speed-related data received from the speed sensor to generate a speed-adjusted overturn angle for the agricultural harvester;
determine at one threshold angle based at least in part on the speed-adjusted overturn angle; and
compare a current stability angle of the agricultural harvester to the at least one threshold angle.
